(19) United States
(12) Patent Application Publication
(10) Pub. No.: US 2008/0128032 A1
(43) Pub. Date: Jun. 5, 2008

(54) MOBILE DEVICE FOR HEATING AND PRESSURIZING FLUID

(76) Inventors: Charles Lapetina, Denver, CO (US); Allan Sand, Shanghai (CN)

Correspondence Address: ERICKSON & KLEYPAS, L.L.C., 800 W. 47TH STREET, SUITE 401, KANSAS CITY, MO, 64112, US

(21) Appl. No.: 11/849,852

(22) Filed: Sep. 4, 2007

Related U.S. Application Data
(60) Provisional application No. 60/824,459, filed on Sep. 4, 2006.

(51) Int. Cl. F16L 53/00; F24H 9/12

(52) U.S. Cl. 137/334; 137/341; 137/335; 122/13.3

(57) ABSTRACT

A portable power washer with an on-demand gas-heated water supply, is provided with a water heater for receiving water from an external water supply and rapidly heating the water by passing it though a heat exchanger proximate one or more gas burners. After the water flows through the heater it flows into a pump adapted for use with hot water and is pressurized by the pump for delivery to a high pressure hose. A nozzle or valve at the end of the hose opposite the pump allows a user to cause a stream of hot, pressurized water to eject from the nozzle and against a surface to be cleaned. The pump may be powered by an electric motor or gasoline engine and the device is typically assembled upon a wheeled cart for ready mobility.

### CROSS REFERENCE TO RELATED APPLICATION

This application claims the benefit of the prior filed, co-pending provisional patent application Ser. No. 60/824,459, filed Sep. 4, 2006, which is hereby incorporated by reference.

### BACKGROUND OF THE INVENTION

The present invention relates to devices for providing heated, pressurized fluid and particularly to high pressure washing devices, and more particularly to a portable pressure washer including a means for heating a stream of water prior to pressurization via a pump, and still more particularly to such a device in which the water is heated by an on-demand water heater comprising a heat exchanger heated by one or more gas-fired burners.

Pressurized washing systems are known in prior art. Pressure washers are often portable and may comprise a pump powered by an electric motor and mounted on a wheeled cart. Water is supplied to the pump from an external source, such as a garden hose, under low pressure but relatively high volume. When activated, the pump draws from the low pressure water supply and increases the fluid pressure creating a high pressure, relatively low volume, water stream that is delivered to a high pressure hose. The end of the high pressure hose typically is fitted with a nozzle that includes a valve that may be selectively opened and closed thereby initiating or halting the flow of a stream of highly pressurized water from the nozzle. The user may thereby utilize the high pressure water device by opening the valve to direct a stream of pressurized water against a surface for cleaning, such as the exterior wall of a building. Additional elements may include a tank for holding detergent cleaning fluid, and tubing and a valve providing a route for the detergent to be drawn from the detergent tank into the pressurized water stream. Pressure washers are also sometimes provided with a tank and heating element for heating the pressurized water before it is expelled from the nozzle. In these systems, water is pumped into the pressurized tank where it is heated for several minutes prior to use. These systems suffer from several disadvantages, namely, the inherent danger to the user of working near pressurized hot water, and the limited supply of water at the desired temperature. Often, either the tank is depleted during use prior to completion of the cleaning operation, or water that is pumped into the tank to re-supply the expelled volume causes the contents of the tank to cool to a sub-optimum temperature. In addition, many such devices in the prior art are heated by burning diesel fuel or oil causing harmful and noxious emissions and necessitating periodic disassembly and cleaning of the heater to remove soot deposits.

Stationary devices for continuously heating water on-demand, as opposed to storing heated water in a hot water tank or reservoir, are known in the prior art. Such devices typically include a metal conduit following a spiral or convoluted path through, or otherwise in contact with, a heat exchanger. The heat exchanger is typically heated by an electric heating element or by flame through use of propane, natural gas, or butane fueled burners. A typical gas used in such devices is commonly known by the acronym LPG (liquid propane gas). Electrically heated devices are often installed under sink counters in restaurant or residential kitchens for selectively and rapidly heating water to temperatures well in excess of those typically found in hot water tanks. These on-demand water heating devices may be constructed so that heating is initiated upon detection of water flow through the system.

It would be advantageous, therefore, for a mobile, high pressure washer to be provided with a means for heating water on-demand continuously during use. It would also be advantageous if such a heating means was provided on the low pressure side of the pump so that tubing, fittings, and valves associated with the heating means would not be subjected to constant high fluid pressure during operation of the device, thereby avoiding the associated dangers and inefficiencies of a pressurized hot water tank.

### BRIEF SUMMARY OF THE INVENTION

A device for producing a pressurized stream of hot liquid in accordance with the present invention includes a frame and a pump for pumping a liquid, the pump supported by said frame and coupled to a means for providing mechanical action to the pump. The pump includes a heat and pressure resistant piston and a heat and pressure resistant gasket for sealing the piston. An on-demand heater in fluid communication with the pump for delivering heated liquid to the pump is also mounted on the frame. The heater includes means for heating liquid continuously flowing through the heater during operation of the pump. A heat-resistant and pressure-resistant hose may be attached to the pump for receiving heated liquid under high pressure.

One embodiment of the invention includes a hot water, high pressure washer comprising a tubular steel, aluminum or plastic frame; wheels attached to the frame to provide for washer mobility; an electrical motor or combustion engine for providing power to the pump; a water inlet fitting for receiving a relatively low pressure external water supply from a source such as a garden hose; an on-demand water heater for heating the water to a desired temperature; a pump, including temperature-resistant gaskets, pistons or piston caps, and piston rings, for receiving heated, relatively low pressure water from the heater and delivering it under relatively high pressure to a pressure and heat resistant hose; and a nozzle provided at the end of the hose distal from the pump, the nozzle typically being provided with a valve for initiating and controlling the flow of water from the hose. A wand or gun comprising a rigid tube with a nozzle at the terminal end and a trigger for initiating the flow of pressurized liquid from the nozzle at the grip may be attached to the end of the hose distal from the pump. The invention may further comprise a pressure-limiting means for controlling operation of the pump to a desired, preselected system pressure. In a preferred embodiment, the water heater includes a heat exchanger heated by a gaseous fuel-fired burner system (an ignition source and one or more gas-fired burners). The preferred fuels for the burners include combustible gaseous fuels such as propane, butane, natural gas or equivalent fuels or mixtures thereof. The pressure washer system may further include a removable fuel tank installed upon the cart and in gaseous communication with the burner system.

Advantages of a high pressure hot water washer according to the present invention include: reduction in water usage for cleaning operations, since hot or warm water typically cleans more efficiently than cold water or water at ambient temperature; reduction in unit weight since no tank or reservoir is required to hold a large volume of heated water; elimination of time spent waiting for prior art hot water washers to heat water, since the present invention heats water on-demand and continuously as water flows through the heater to the pump and nozzle; reduction in the emission of pollutants, since on-demand heaters of the type used in the present invention burn propane and other relatively clean-burning fuels as opposed to diesel burners often used to heat the hot water tanks of prior art hot water washers; versatile use as a cold-water high pressure washer by reducing or halting the gas flow to the heater burners; versatile use as a low pressure hot water supply by turning off or disconnecting the pump so that the flow of water is maintained by pressure provided by the water source; and, safe indoor use through utilizing an alternative embodiment of the invention including an electric motor for providing power to the pump and a heater including electric heat elements versus gas burners.

A method according to the present invention includes the steps of passing water through a heater, the heater comprising a coil mounted proximate a heat exchanger that is mounted proximate one or more gas burners, engaging an igniter proximate the burners to ignite and burn any residual gas proximate the burners, flowing a combustible gas to the burners, engaging the igniters to ignite the gas flowing from the burners, flowing water heated within the coil by the burners from the coil to the inlet of a pump in fluid communication with the coil, and moving one or more ceramic pistons within the pump past a heat-resistant gasket to pressurize the heated water and eject the heated water from an outlet of the pump to a high pressure and high temperature resistant hose in fluid communication with the outlet.

Other advantages of the invention will become apparent from the following description taken in connection with the accompanying drawings, wherein is set forth by way of illustration and example an embodiment of the present invention.

### BRIEF DESCRIPTION OF THE SEVERAL VIEWS OF THE DRAWINGS

FIG. 1 is a front elevational view of a water heating and pressurization apparatus.

FIG. 2 is a top plan view of the apparatus of FIG. 1.

FIG. 3 is a side elevational view of the apparatus of FIGS. 1 and 2.

FIG. 4 is a rear elevational view of the apparatus of FIGS. 1 through 3.

FIG. 5 is a cutaway view of the heater showing various internal details.

FIG. 6 is a side elevational view of an alternative embodiment of a water heating and pressurization apparatus.

FIG. 7 is a side elevational view of the apparatus of FIG. 6 showing the hood tilted forward to provide access to the removable gas fuel tank.

FIG. 8 is a top and front perspective view of an embodiment of a water heating and pressurization apparatus.

FIG. 9 is a top and rear perspective view of an embodiment of a water heating and pressurization apparatus including a rearwardly projecting frame extension for holding a gaseous fuel tank.

FIG. 10 is a top and front, perspective and exploded view of the apparatus of FIG. 8.

### DETAILED DESCRIPTION OF THE INVENTION

As required, a detailed embodiment of the present invention is disclosed herein; however, it is to be understood that the disclosed embodiment is merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

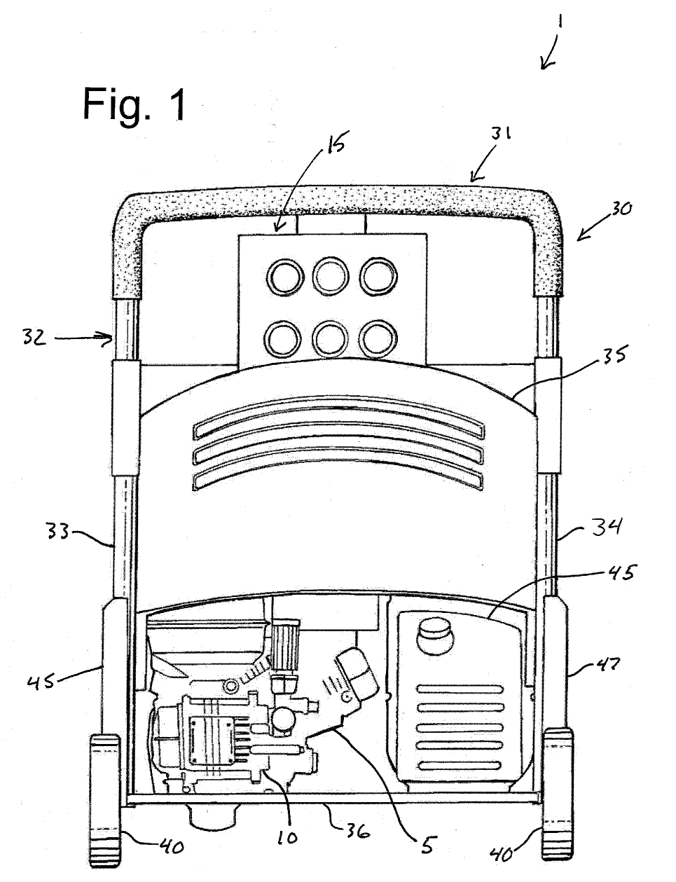

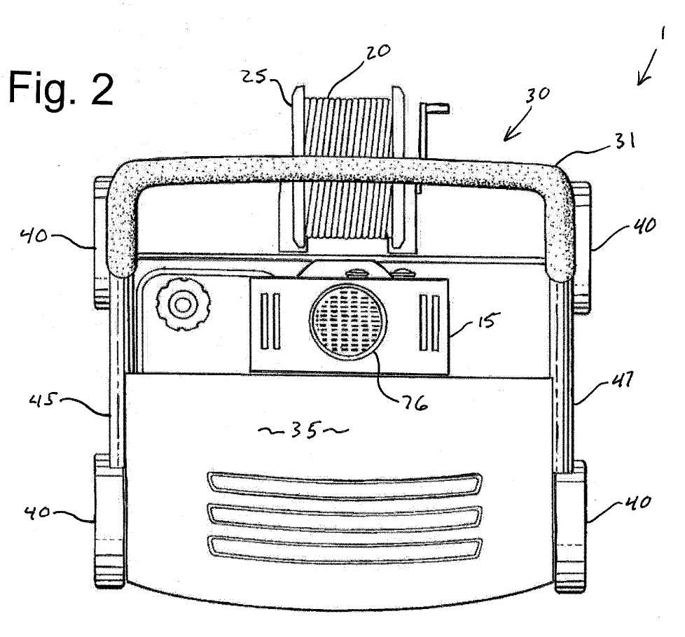

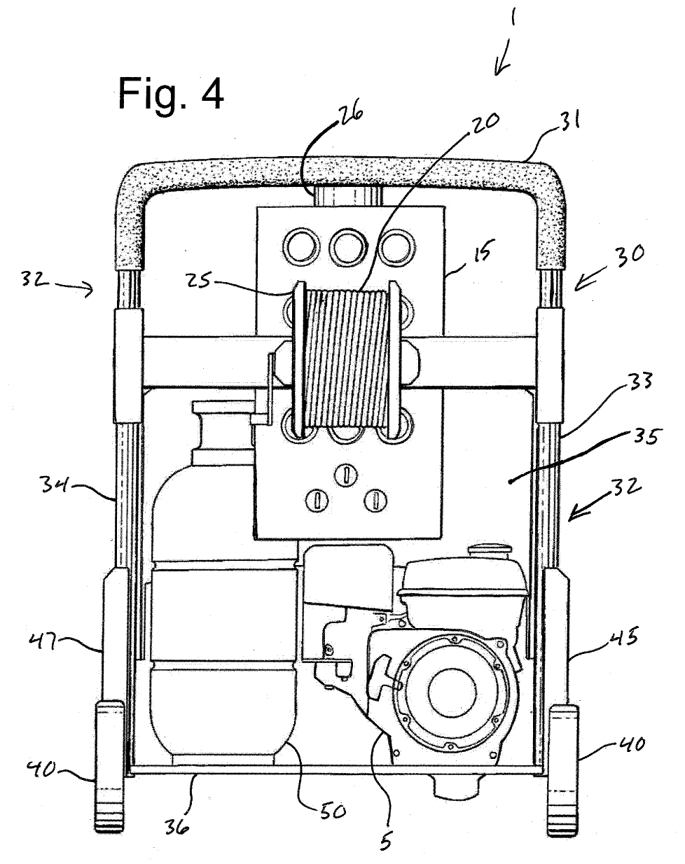

Referring now to FIGS. 1 through 7 of the drawings, there is shown a portable water heating and pressurization apparatus, in this particular embodiment a high pressure washer, indicated by the reference numeral 1. Only selected elements of the washer 1 are shown and described herein as it should be appreciated that high pressure washers and their function, structure and assembly, absent the improvements of the present invention, are well known in the prior art. As illustrated, the washer 1 comprises a combustion engine 5 (such as a gasoline or diesel engine) that powers a fluid pump 10 that draws heated water through and from an on-demand fluid heater 15 and delivers it to a pressure and heat resistant hose 20. The heater 15 may typically be selected from the prior art to heat the required volume per time unit of water anticipated for use in washing operations to an elevated temperature relative to the temperature of water entering the heater 15.

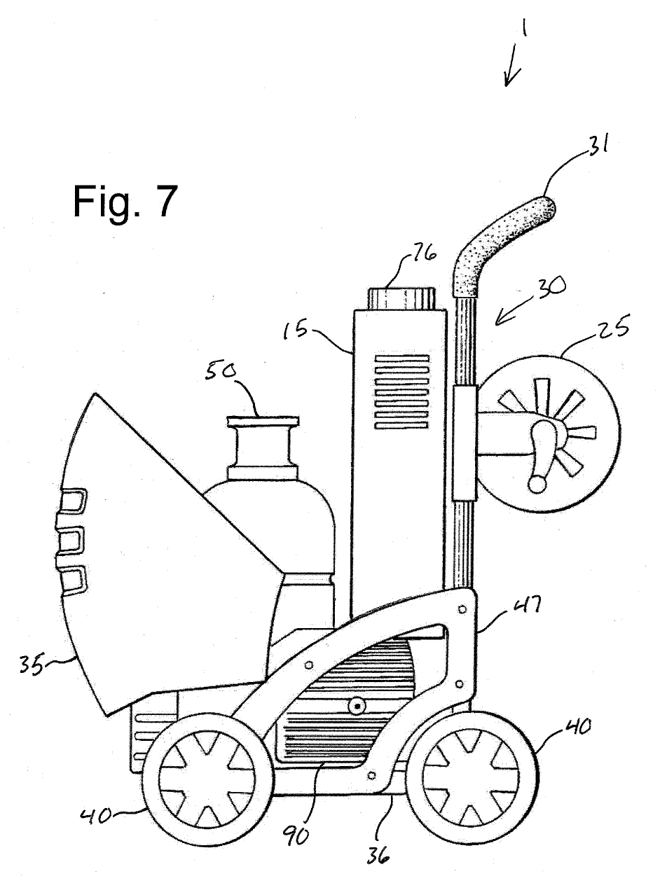

The hose 20 is coiled upon a reel 25 attached to a frame 30. The reel 25 is typically sized to accommodate a hose 20 approximately 30 meters in length. The frame 30 may comprise any appropriate rigid material such as plastic or tubular steel, but preferably comprises tubular aluminum covered in selected areas, such as the handle 31, with rubber. The frame 30 provides a structure for attaching washer components such as the pump 10, engine 5, and reel 25. A hood 35, comprising a curved metal, fiberglass, or plastic panel, is hingedly attached to the frame 30 so that it may be titled forward as shown in FIG. 7. The hood 35 provides a covering for protecting the pump 10, engine 5 and other components from dust, spray from the hose 20 when in operation, and the elements; for dampening engine noise; and for providing an aesthetically pleasing outer appearance. Wheels 40 attached to the lower portion of the frame 30 provide mobility, allowing the washer 1 to be rolled from one location to another.

Other components and features of the washer include a detergent reservoir or tank 46 in fluid communication with the fluid stream, wherein detergent may be drawn from the detergent tank 46 and expelled through the nozzle 92 of the hose 20 along with water pressurized by the pump 10. A temperature and/or pressure safety valve (not shown) is in fluid communication with the heater 15 and is calibrated or constructed to allow hot water to vent from the heater 15 prior to rupture of heater 15 due to over-pressurization related to over-heating.

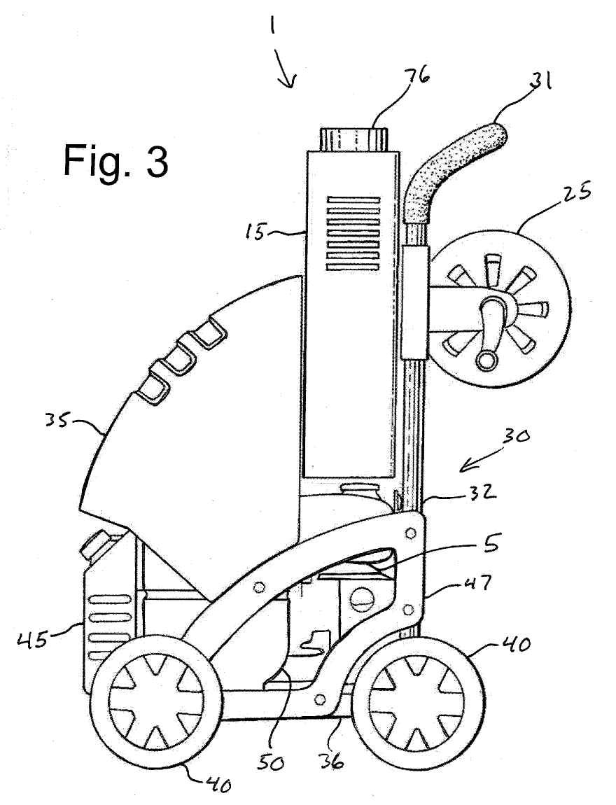

The frame 30 may comprise a U-shaped piece 32 of rigid material, such tubular aluminum, having a horizontal handle 31 and downwardly extending arms 33 and 34. Side brackets 45 and 47 attach to the lower portions of the arms 33 and 34, respectively, and extend forward. A horizontally disposed bottom plate 36 or equivalent structure is attached to the lower portions of the side brackets 45 and 47 to extend therebetween and provide a support platform for washer 1 components such as the pump 10, engine 5, detergent tank 46 and associated subcomponents such as valves, connecting tubing and other fittings. As shown in FIGS. 3, 4, 7 and 9, the washer 1 assembly may further include a gaseous fuel tank 50, such as disposable or refillable propane tanks 50 commonly found in the prior art, for providing gaseous fuel to the heater burners 55.

The burners 55 are ignited via an electrical, battery powered ignition system. In one embodiment, the heater burners 55 are ignited using one or more ignition pins 73 and 74. The ignition pins 73 and 74 produce a spark when provided the proper current by the three volt automatic pulse ignition. The primary component of the automatic pulse ignition is the pulse generator 70 that is typically powered by a power supply 81 containing two standard “A” size batteries. Unlike prior art on-demand heaters, the heater 15 used in some embodiments of the present invention starts ignition prior to initiating the flow of gas. This assures that all gas is combusted before initiating heating and limits the quantity of gas resident in the heater 15 during ignition.

The ignition system may include a gas flow detector that causes the ignition system to activate, producing a spark in proximity to one or more of the burners 55, upon detecting flow of gaseous fuel to the burners 55. The heater burners 55 and associated thermostat and fuel-control valves are typically calibrated to heat water passing through the heater 15 to a temperature between 60 and 70° C.

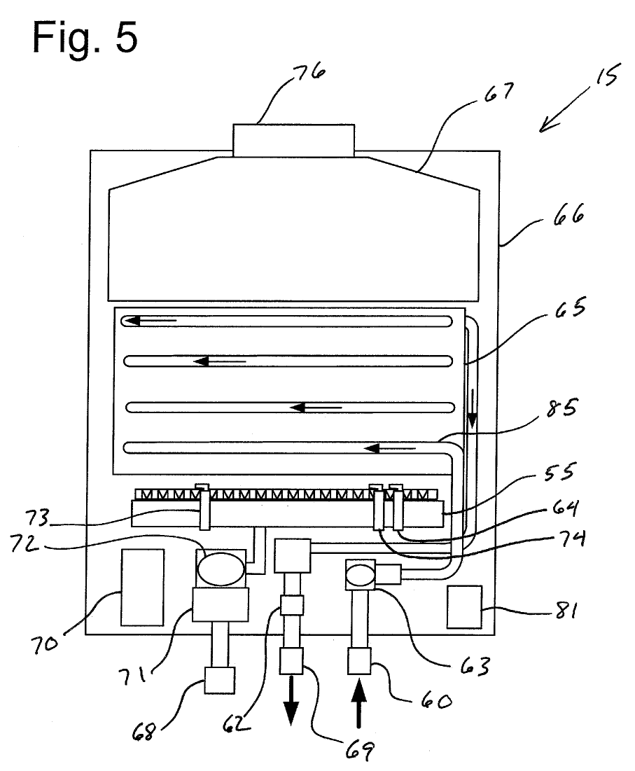

The heater 15, external views shown in FIGS. 1-4, 6 and 7 and internal view shown in FIG. 5, may comprise a winter/summer switch for adjusting the calibration of the thermostat to account for higher or lower ambient temperatures, a water inlet 60 for receiving water from an external source such as spigot or tap connected to a municipal water supply (typically via garden hose 57), a water discharge valve 61, a micro-active switch 62, a water adjusting valve 63 for adjusting the flow rate of water through the heater 15, a sensor pin 64 for controlling heater fuel combustion, a primary ignition pin 73 for igniting one or more burners, one or more burners 55 for heating a heat exchanger 65, a back plate 66 that provides a support surface for heater 15 components, a combustion fume collection hood 67 for collecting combustion fumes produced by the burner 55, a gas inlet 68 for receiving gaseous fuel from the fuel tank 50, a hot water outlet 69 from which heated water flows from the interior of the heater 15 to the hose 20 via the pump 10, a pulse generator 70, a solenoid valve 71, a gas adjusting valve 72 for increasing or decreasing the flow of gaseous fuel from the tank 50 to the burner 55, a secondary ignition pin 74 for igniting one or more burners 55, a protection pressure switch 75, and, optionally, an exhaust motor for driving an exhaust fan that draws combustion fumes upward and through the fume collection hood to exit the top of the heater 15 through the exhaust pipe 76. The heater 15 is attached to the frame 30 using threaded fasteners each surrounded by an elastomeric collar comprising rubber or rubber-like material, such as ethylene propylene diene monomer, to isolate the heater from vibration caused by the engine 5. The dampening effect of the rubber collars between the heater 15 and the frame 30 ensure that only minimal vibration is transferred from the engine 5 to the heater 15.

The water inlet 60 and water outlet 69 are in fluid communication with one another via an elongate, generally tubular, fluid-confining conduit 85 coiled within the heater 15 about and/or within the heat exchanger 65. The heat exchanger 65 and the conduit 85 (also referred to herein as a coil) each comprise a material adapted for heat-transference such as copper or aluminum. The heat exchanger 65 is positioned within the heater proximate and above a means for generating heat, such as an electric heating element or one or more gas burners 55. Heat from the heat generation means (gas burner 55) is transferred via the heat exchanger 65 to the coil 85 and then to water flowing through the coil 85. Typically, the water is heated to between 60 and 70° C., a temperature range typically optimal for cleaning operations.

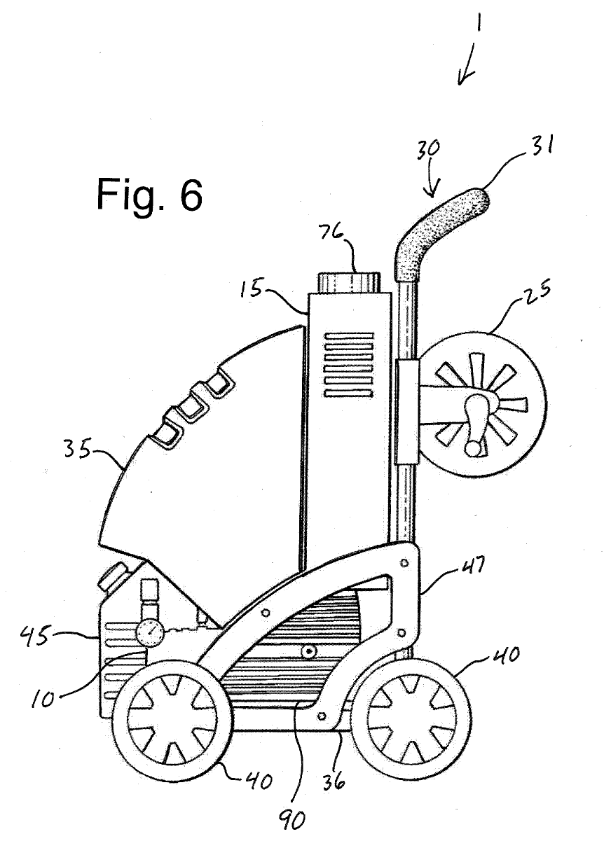

In an alternative embodiment of the washer 1, shown in FIGS. 6 and 7, the pump 10 is powered by an electric motor 90 instead of a gasoline engine 5. Typically, the flow rate of water through the heater 15 is calibrated to provide a 25° C. change in water temperature after passage through the heater 15.

The pump 10 receives heated water from the heater 15 and includes internal seals, gaskets and piston caps comprising heat resistant materials such as VITON® (fluorocarbon rubber), styrene butadiene rubber, butyl rubber, chloro butyl rubber, bromo butyl rubber, nitrile rubber (acrylonitrile butadiene rubber), neoprene (chloroprene rubber), ethylene propylene diene rubber, TEFLON® (polytetrafluoroethylene or PTFE), HYPALON® (chlorosulphonated polyethylene), fluorosilicon rubber, and/or urethane. The pump 10 typically has one to four pistons. During operation of the pump 10, reciprocating movement of a piston relative to a piston seal or gasket fixed within the pump 10, draws fluid from the heater 15 and thereafter expels the fluid at high pressure from the pump 10.

Preferably, the pistons comprise a ceramic material, at least on the portion of the outer piston surfaces that contact the hot water being pumped and slide past the piston seal. Although the piston seal may comprise any of various heat-resistant polymer materials, it preferably comprises fiber-armed PTFE. An appropriate fiber-armed PTFE seal may be obtained from Trelleborg, AB, Germany. The piston may comprise a solid rod of ceramic or may comprise an outer, cylindrical sleeve of ceramic fitted upon an inner rod of steel or other suitable material. Ceramic typically comprises aluminum oxide and a binder and may contain other constituents such as manganese oxide, silicon oxide, zirconium oxide, and hafnium oxide. A suitable ceramic for use in high pressure pumps for pumping heated fluids, or pumps equipped with ceramic pistons, may be selected from the prior art. An appropriate pump 10 may have a working pressure range of approximately 60 to 200 bar and a working flow rate of approximately 11 to 15 liters per minute, although pressures and flow rates outside of these ranges may also be operable.

After connecting a water supply source to the water inlet 60, the typical heating sequence includes user activation of a trigger 94 on a handle 88 of the hose 20. Trigger activation causes water to flow through the washer 1 fluid path including through the heater 15 and pump 10. The flow of water activates the micro-active switch 62 which initiates the flow of electricity from the power supply 81 to the pulse generator 70. The pulse generator 70 supplies pulses of electricity to the ignition pins 73 and 74 causing them to generate sparks in proximity to the burners 55. Subsequently, the solenoid valve 71 opens allowing gas to flow from the fuel tank 50 to the gas inlet 68 and then to the burners 55, where flame is ignited by the ignition pins 73 and 74. Heat from the burner 55 flames rises to heat the heat exchanger 65. As water at ambient temperature flows into the heater 15 from the water source it is thereby heated as it passes through the heat exchanger 65. Heated water exits the heater 15 through the hot water outlet 69 and then flows through a heat and pressure resistant hose 87 to the pump 10 where it is pressurized. Preferably, the hose 87 used to connect the heater 15 to the pump 10 is selected as capable of withstanding over 300 psi, since activation and release of the trigger 94 on the spray gun 88 may create a surge of back pressure through the fluid flow path of the washer 1. Pressurized hot water flows from the pump 10 to the high pressure hose 20 and exits the hose 20 at the nozzle 92.

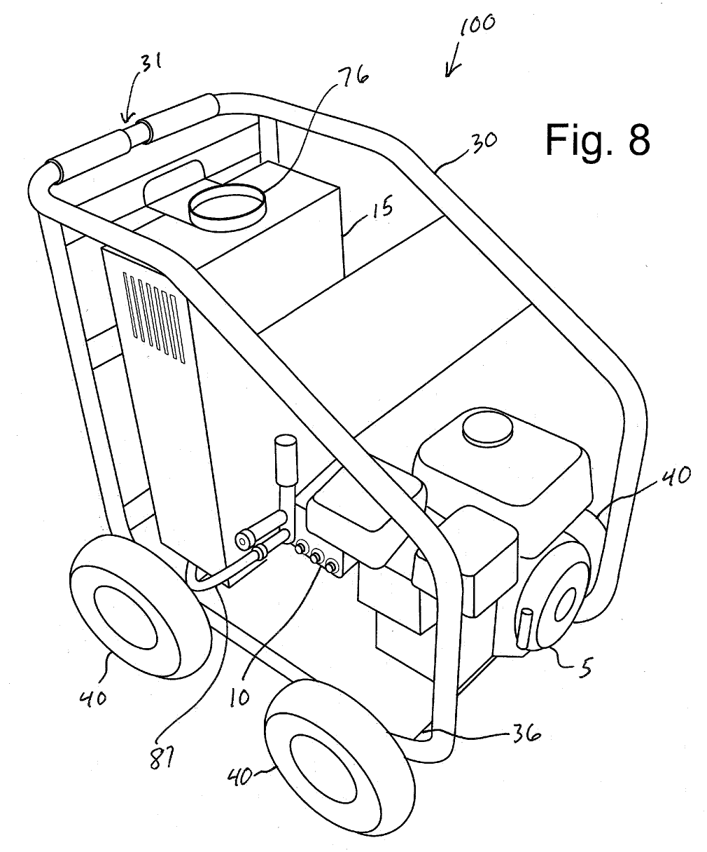

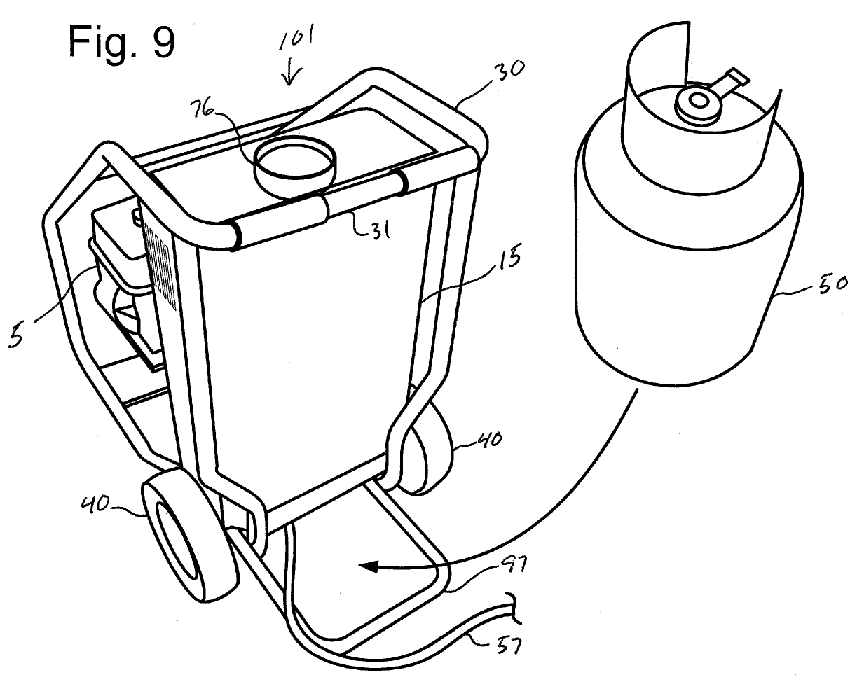

FIGS. 8 and 9 illustrate two variations 100 and 101 on a further embodiment of the invention. FIG. 8 illustrates an embodiment of a washer 100 wherein the heater 15, pump 10 and engine 5 are mounted in an open frame 30. FIG. 9 illustrates an embodiment of a washer 101 wherein the frame 30 includes a generally horizontal extension 97 extending from the lower rear portion of the frame 30 and adapted to receive and hold the tank 50. In addition, extension 97 serves as a foot lever for raising the front portion of the washer 101 so that the washer 101 may be wheeled about on the rear wheels 40. When depressing extension 97 the front of the frame 30 is rocked upward as the frame 30 pivots about the wheels 40.

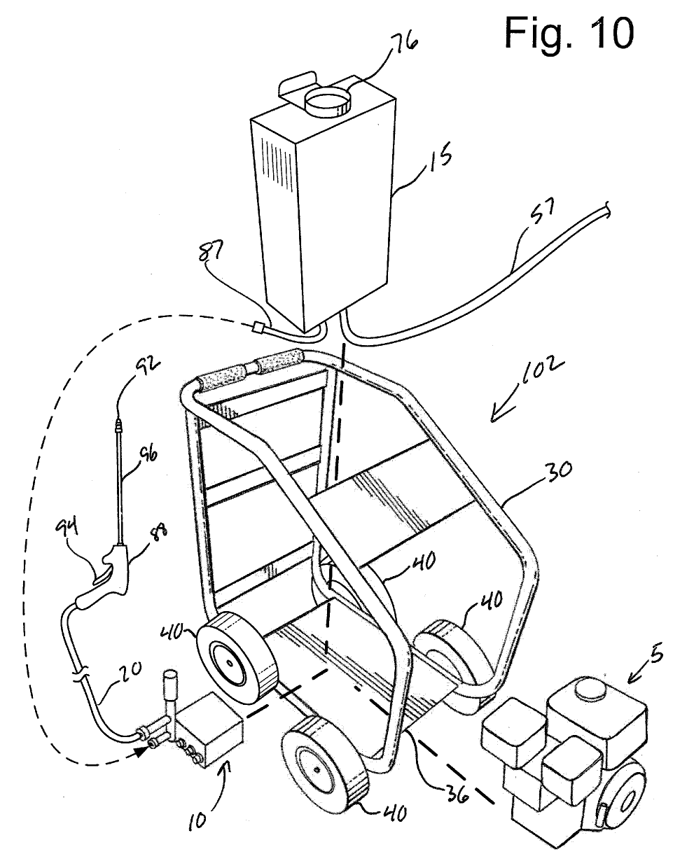

FIG. 10 is a is an exploded view of the washer 101 of FIG. 8 additionally showing a spray gun 88, with trigger 94, wand 96, and nozzle 92, mounted on the high pressure hose 20 leading from the pump 10.

It is to be understood that while certain forms of this invention have been illustrated and described, it is not limited thereto except insofar as such limitations are included in the following claims and allowable equivalents thereof. It should be appreciated, that the washer 1 may both with and without heating water as it passes through the heater 15.

Having thus described the invention, what is claimed as new and desired to be secured by Letters Patent is as follows:

1. An apparatus for creating a stream of high-temperature, high-pressure fluid, comprising:
an on-demand fluid heater for heating fluid continuously flowing through said heater, whereby fluid exiting said heater is at an elevated temperature relative to the temperature of fluid entering said heater, said heater including a fluid inlet for receiving fluid, a fluid outlet for flowing heated water from said heater, said inlet and outlet connected to one another by elongate, generally tubular, fluid-confining conduit coiled within said heater about a heat exchanger, said heat exchanger and said coil each comprising a material adapted for heat-transference, said heat exchanger positioned within said heater proximate a means for generating heat, whereby heat from said means for generating heat is transferred via said heat exchanger to said coil and then to fluid flowing through said coil,
a liquid pump connected to said fluid heater for receiving heated fluid exiting said heater via said outlet, said liquid pump including a reciprocating piston comprising heat resistant ceramic and a gasket for sealing around said piston, said gasket comprising heat-resistant and pressure-resistant polymer, and
means for applying force to said piston to cause reciprocating movement of said piston relative to said gasket within said pump, whereby said reciprocating movement of said piston draws said fluid from said heater and thereafter expels said fluid at high pressure from said pump.

2. The apparatus of claim 1 wherein said means for generating heat comprises an electric heating coil.

3. The apparatus of claim 1 wherein said means for generating heat comprises a gas burner.

4. The apparatus of claim 1 further comprising a combustion engine mounted upon said frame, said engine coupled to said pump to provide motive force to said piston.

5. The apparatus of claim 1 further comprising an electric motor mounted upon said frame, said motor coupled to said pump to provide motive force to said piston.

6. The apparatus of claim 1 further comprising a pressure resistant hose in fluid communication with said pump for receiving pressurized fluid expelled from said pump.

7. The apparatus of claim 6 further comprising a detergent reservoir in fluid communication with said pump, whereby detergent may be drawn from said reservoir and expelled through said hose.

8. A device for pressurizing a heated liquid, comprising
a frame,
a pump for pumping a liquid, said pump supported by said frame and coupled to a means for providing mechanical action to said pump, said pump including a heat and pressure resistant piston and a heat and pressure resistant gasket for sealing said piston,
a heater in fluid communication with said pump for delivering heated liquid to said pump, said heater including means for heating liquid continuously flowing through said heater during operation of said pump, and
a heat-resistant and pressure-resistant hose for receiving heated liquid under high pressure from said pump.

9. The device of claim 8, wherein said heater includes a gas burner for heating said liquid flowing through said heater.

10. The device of claim 9, wherein said burner is adapted to burn a combustible fuel selected from the group consisting of propane, butane, natural gas or mixtures thereof.

11. A portable power washer for providing an on-demand, gas-heated supply of water, comprising:
a water heater including an inlet for receiving water from an external water source and conveying said water to a coil mounted within said heater and above a one or more gas burners, said coil comprising a material selected for ready heat transference,
said heater further including an outlet in fluid communication with said coil,
a pump in fluid communication with said outlet for receiving heated water from said heater, said pump including means for pressurizing said water for delivery to the proximate end of a high pressure hose, said high pressure hose including nozzle at the distal end of said hose,
a valve in fluid communication with said hose for allowing a user to selectively cause a stream of hot, pressurized water to eject from said nozzle and against a surface to be cleaned,
a frame for supporting said heater and said pump, said frame including one or more wheels for at least partially supporting said frame upon surface.

12. The portable power washer of claim 11 wherein said coil is mounted at least partially within a beat exchanger proximate one or more gas burners.

13. The portable power washer of claim 11 wherein said pump is powered by an electric motor.

14. The portable power washer of claim 11 wherein said pump is powered by a combustion engine.

15. A method for rapidly and continuously heating water during operation of a power washer, comprising the steps of:
passing water through a coil mounted proximate a heat exchanger that is mounted proximate one or more gas burners,
flowing a combustible gas to the burners, igniting the gas at the burners,
flowing heated water from the coil to the inlet of a pump in fluid communication with the coil,
moving one or more ceramic pistons within the pump past a heat-resistant gasket to pressurize the heated water and eject the heated water from an outlet of the pump to a high pressure and high temperature resistant hose in fluid communication with the outlet, and
spraying heated water from the nozzle of the hose.
